(19) United States
(12) Patent Application Publication
(10) Pub. No.: US 2014/0004808 A1
(43) Pub. Date: Jan. 2, 2014

(54) ANTENNA CONFIGURATION STRUCTURE OF AN NFC (NEAR FIELD COMMUNICATION) ENABLED MEDICAL DEVICE

(71) Applicants: Chun-Ying LI, New Taipei City (TW); Yi-Lung Chen, New Taipei (TW); Wen-Yu Tsai, New Taipei City (TW)

(72) Inventors: Chun-Ying LI, New Taipei City (TW); Yi-Lung Chen, New Taipei (TW); Wen-Yu Tsai, New Taipei City (TW)

(21) Appl. No.: 13/539,699

(22) Filed: Jul. 2, 2012

(51) Int. Cl. H04B 5/02; H04B 1/38

(52) U.S. Cl. 455/90.2

(57) ABSTRACT

The present invention provides an antenna configuration structure of an NFC (Near Field Communication) enabled medical device and comprises: a case body; a screen installed on the case body to display physiological parameters and having a screen area; an NFC-enabled module provided with a wireless antenna for data exchange wherein the wireless antenna is arranged as a coiled body which encloses an antenna area overlapping at least one region of the screen area. As such, a user who institutively approaches his/her portable device near to the screen of the NFC-enabled medical device is able to exchange data due to identical positions of the antenna and the screen in the NFC-enabled medical device as medical equipment with excellent convenience in structural design and sensing as well as a humanized interface.

### BACKGROUND OF THE INVENTION

1) Field Of The Invention

The present invention relates to a medical device, particularly an NFC (Near Field Communication) enabled medical device based on configuration of a screen's position for convenient sensing.

2) Description Of The Prior Art

It is necessary for current medical equipment to transfer all kinds of measured physiological information (e.g., body temperature, pulse rate, blood pressure, blood glucose, blood oxygen saturation, EKG, ECG, and respiration parameter) by means of one transmission device which links cable network equipment or wireless network equipment but causes operations inconvenient and time-consuming due to limitations in transmission of physiological information such as connected cables, wireless pairing, and settings. Obviously, the existing method for communication of information is unsatisfactory because any physiological parameter measured by one patient himself/herself at home is difficultly transmitted in the case of a patient who is too old, disabled, or unfamiliar with operations of equipment. In addition, a NFC (Near Field Communication) system as one contactless short-distance point-to-point communication system of equipment has evolved with a Radio Frequency Identification (RFID) system and interconnection technology integrated. Thus, the NFC-based medical devices have emerged in virtue of accepted ISO standards on the basis of interface and communication protocols.

Based on an NFC reader/writer/tag module to realize near field communication and sensing, the above NFC-enabled medical device usually relies on the position of its internal antenna which is marked on the medical device's panel for completion of sensing within a proper distance (10 cm or so), or the user may have no idea to operate the device. However, it might be perplexedly inconvenient to design or use the NFC-enabled medical device because of (1) design of the medical device's panel on which there are various buttons or no proper position marked for an antenna or (2) the medical device's volume and area increased to accommodate an antenna and indicate a mark for sensing, respectively. Thus, the persons skilled in the arts should make all efforts to overcome inconvenience or perplexity in designing an NFC medical device, incorporating the general public's habits for NFC-enabled applications such as Easy Cards and Octopus Cards in daily life into an NFC-enabled medical device for smooth usage of this device.

Accordingly, the inventor having considered shortcomings derived from an NFC medical device and attempted to optimize its antenna's structure for sensing has studied and developed a solution for one user-friendly NFC-enabled medical device matching most consumers' operating habits and promoting development of the industry.

### SUMMARY OF THE INVENTION

The object of the present invention is to provide an antenna configuration structure of an NFC-enabled medical device in which positions of the antenna and the screen are designed identically so that the NFC-enabled medical device which has excellent convenience in structural design and sensing conforms to the general public's habits for operations of sensors and further realizes a humanized medical device.

To realize the above object, the present invention adopts technical measures comprising: a case body; a screen installed on the case body to display physiological parameters and having a screen area; an NFC-enabled module provided with a wireless antenna for data exchange wherein the wireless antenna is arranged as a coiled body which encloses an antenna area overlapping at least one region of the screen area.

For technical features and effects in terms of the present disclosure completely understood and recognized, the preferred embodiments and detailed drawings are described hereinafter.

### BRIEF DESCRIPTIONS OF THE DRAWINGS

FIG. 1 is the schematic illustration of a circuit structure for the present invention in the first embodiment.

FIG. 2 is the exploded view of the present invention in the first embodiment.

FIG. 3 is the exploded view of the present invention in the second embodiment.

FIG. 4 is the schematic illustration for the assembled present invention in the second embodiment.

### DETAILED DESCRIPTIONS OF THE PREFERRED EMBODIMENTS

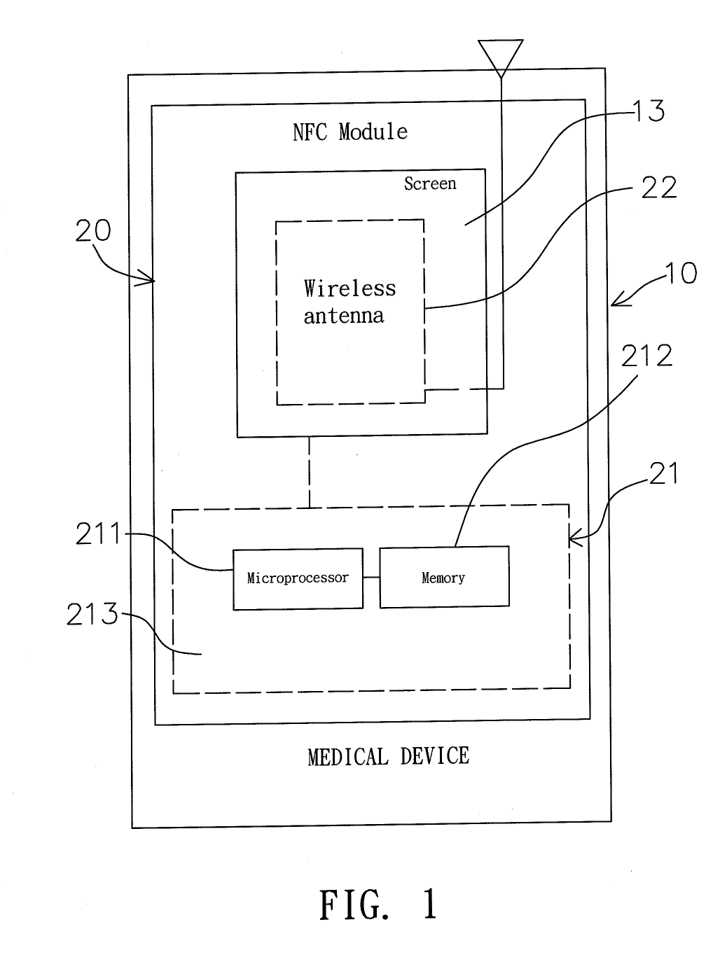

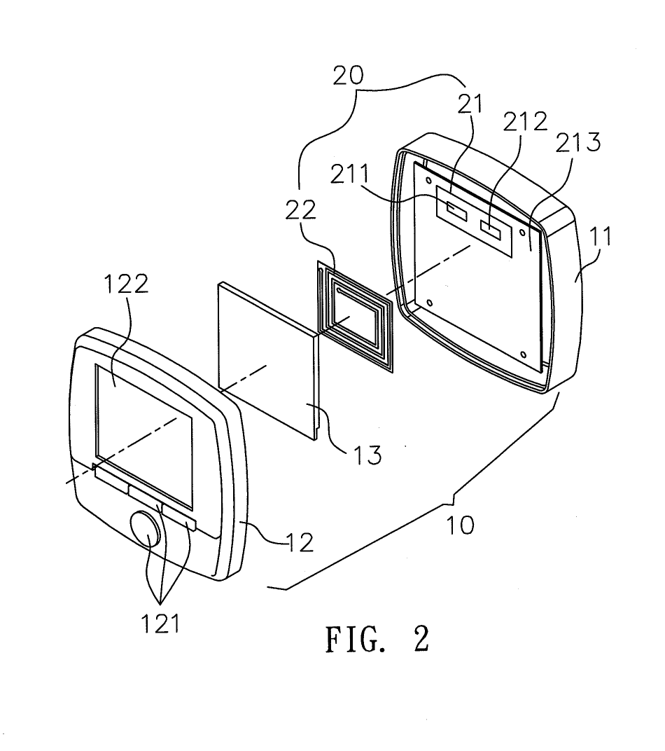

Referring to FIGS. 1 and 2 which illustrate the first embodiment for an antenna configuration structure in the present invention of an NFC (Near Field Communication) enabled medical device comprising a medical device 10 and an NFC (Near Field Communication) module 20: the medical device 10 is able to catch at least one physiological parameter from one person such as body temperature, pulse rate, blood pressure, blood glucose, blood oxygen saturation, electrocardiogram (EKG or ECG) and respiration parameter and has case body comprising a machine body 11 and a front cover 12 wherein the machine body 11 is provided with electronic medical devices (not shown in figures) used in configuring the NFC module 20 and the front cover 12 installed on the machine body 11 is provided with a plurality of buttons 121 and a display window 122 in which there is a corresponding screen 13 electrically connected to the NFC module 20 for displaying relative medical information and covering a screen area. The NFC module 20 disposed in the medical device 10 can be an NFC reader/writer or an NFC tag comprising a control circuit 21 and a wireless antenna 22: the control circuit 21 further comprises a microprocessor 211 and a memory 212, both of which are installed on a circuit board 213, wherein the microprocessor 211 provides functions such as reading, writing, algorithm, authentication and encryption and the memory 212 is used to store data exchanged via the wireless antenna 22 that receives radio waves from an external portable NFC reader/writer/tag module. The abovementioned data comprises individual information (e.g., name, ID number, height, weight, physiological data etc.), date and time information. The wireless antenna 22 emitting radio waves with a frequency of 13.56 MHz is developed as a coiled body (e.g., square-ring wiring or circular-ring wiring) and installed behind the screen 13; the coiled body encloses an antenna area for the wireless antenna 22 which overlaps or is projected onto a screen area of the screen 13, that is, the screen area totally covers the antenna area.

Furthermore, the antenna area which is enclosed by the coiled body of the wireless antenna 22 develops an effectively inductive field with a wireless inductive center which corresponds to and is projected on the screen area. Certainly, the screen area has a geometric center so that the wireless inductive center corresponds to and is projected on the geometric center.

In the NFC module 20 installed on the circuit board 213, both the control circuit 21 and the circuit board 213 are integrated with the abovementioned relative electronic medical devices in the medical device 10, that is, these components constitute electronic medical equipment for measuring physiological parameters such as pulse, blood pressure, blood glucose, blood oxygen saturation, and electrocardiogram, simplify the medical device 10, and reduce manufacture and maintenance costs.

Furthermore, the medical device 10 as electronic medical equipment used in measuring physiological parameters such as pulse, blood pressure, blood glucose, blood oxygen saturation, and electrocardiogram is also one physiological data detector which is based on the present invention for improved functions, convenience and availability.

In a preferred embodiment, the portable NFC reader/writer/tag module can be a smart mobile phone, that is, an NFC tag or an NFC reader/writer is integrated with a smart mobile phone; or the portable NFC reader/writer/tag module can be a tablet or a notebook computer, that is, an NFC tag or an NFC reader/writer is integrated with a tablet or a notebook computer.

In addition, the portable NFC reader/writer/tag module can be shaped to a round coin or a piece of paper and regarded as an NFC tag; or the portable NFC reader/writer/tag module is a contactless smart card, that is, an NFC tag is integrated with a contactless smart card such as an Easy Card, an Octopus Card, an E-Wallet or a credit card.

A method of operating the present invention of an NFC-enabled medical device is to bring the portable NFC reader/writer/tag module close to the screen 13 of the medical device 10 which is taken as one target of proximity sensing during an inductive operation between the portable NFC reader/writer/tag module and the medical device 10 so that data is automatically exchanged from the NFC module 20 of the medical device 10 to the portable NFC reader/writer/tag module which approaches the screen 13 of the medical device 10 within a specific distance (e.g., less than 10 cm). Alternatively, the medical device 10 is automatically turned on when the portable NFC reader/writer/tag module approaches the medical device 10 within a specific distance (e.g., less than 10 cm) and is detected by the NFC module 20. In other words, the NFC module 20 within a range which sensing is available is activated by radio waves from the portable NFC reader/writer/tag module, so as to generate current based on electromagnetic induction and trigger the microprocessor 211 on the NFC module 20 for emission of electromagnetic waves responding the portable NFC reader/writer/tag module.

As such, neither the position of the wireless antenna 22 nor any mark on the front cover 12 for sensing the wireless antenna 22 in design of the medical device 10 are required. In the present invention, the wireless antenna 22 relies on the screen 13 as an object for proximity sensing, that is, an inductive operation between the portable NFC reader/writer/tag module and the medical device 10 is based on the screen 13 for proximity sensing and is completed by one user who instinctively brings a portable device (NFC reader/writer/tag module such as smart mobile phone, tablet computer, notebook computer or smart card) near to the screen of the NFC-enabled medical device for sensing and data exchange. Accordingly, a product with simple elegant quality is designed and prevents the screen 13 from a mark for sensing which complicates operations of the front cover 12.

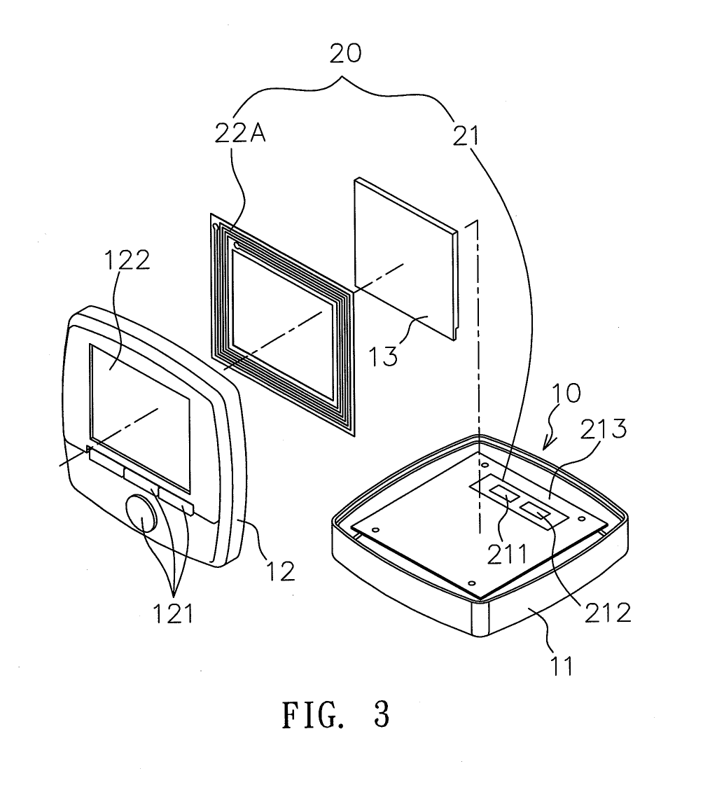

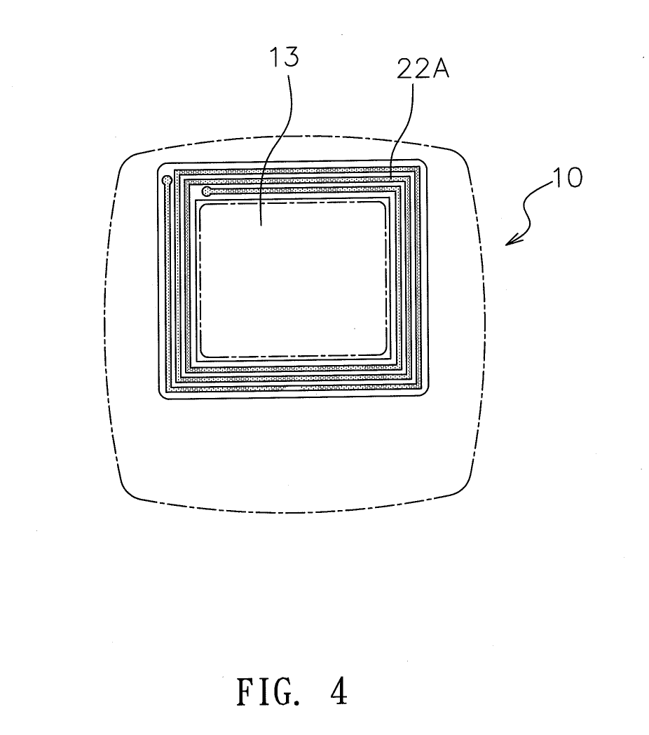

Referring to FIGS. 3 and 4 which illustrate the second embodiment for an antenna configuration structure in the present invention of an NFC-enabled medical device is based on the first embodiment and has some changes as follows: the wireless antenna 22A as coiled body with ring-type wiring is disposed around the screen 13, that is, the coiled body or the wireless antenna 22A is located at borders between the screen 13 and the machine body 11 (front cover 12) of the medical device 10. The wireless antenna 22A has an antenna area which is enclosed by the coiled body so that the antenna area covers the screen area of the screen 13 or is developed as an effectively inductive field in which there is a wireless inductive center corresponding to and projected on the screen area. Furthermore, the screen area has a geometric center and the wireless inductive center corresponds to and is projected on the geometric center. In addition, the abovementioned wireless antenna 22 (or 22A) can be an enameled wire which is developed as ring-type wiring and fully protects the wireless antenna 22 (or 22A). Alternatively, the wireless antenna 22 (or 22A) can be a circuit board with ring-type wiring manufactured as the wireless antenna 22 (or 22A) and characteristic of simplified process as well as reduced costs.

According to the above descriptions, the antenna configuration structure in the present invention of an NFC-enabled medical device features identical positions of the antenna and the screen so that sensing and data exchange are completed by one user who intuitively brings a portable device (NFC reader/writer/tag module such as smart mobile phone, tablet computer, notebook computer or smart card) close to the screen of the NFC-enabled medical device. As such, the NFC-enabled medical device which has excellent convenience in structural design and sensing conforms to the general public's habits for operations of sensors and further realizes a humanized medical device.

It can be seen from the above descriptions that the present invention significantly meets patentability and is applied for the patent. However, the above descriptions present preferred embodiments only which do not limit the scope of the present invention; any equivalent change or improvement based on shapes, structures, features and spirit mentioned in the present invention should be incorporated in claims.

What is claimed is:

1. An antenna configuration structure of an NFC-enabled medical device for catching at least one physiological parameter from one person, comprising:
A case body;
A screen installed on said case body for display of physiological parameters and having a screen area; and
An NFC-enabled module provided with a wireless antenna for data exchange wherein said wireless antenna is developed as a coiled body with ring-type wiring and enclosing an antenna area which overlaps at least one region of said screen area.

2. The antenna configuration structure of said NFC-enabled medical device according claim 1 wherein said medical device is one physiological data detector.

3. The antenna configuration structure of said NFC-enabled medical device according claim 2 wherein said medical device catches at least one physiological parameter such as body temperature, pulse rate, blood pressure, blood glucose, blood oxygen saturation, electrocardiogram (EKG or ECG) and respiration parameter.

4. The antenna configuration structure of said NFC-enabled medical device according claim 1 wherein said antenna area is projected on said screen area.

5. The antenna configuration structure of said NFC-enabled medical device according claim 1 wherein said antenna area is used to generate an effectively inductive field with a wireless inductive center which corresponds to and is projected on the screen area.

6. The antenna configuration structure of said NFC-enabled medical device according claim 5 wherein said screen area has a geometric center and said wireless inductive center corresponds to and is projected on said geometric center.

7. The antenna configuration structure of said NFC-enabled medical device according claim 1 wherein said wireless antenna is installed behind said screen.

8. The antenna configuration structure of said NFC-enabled medical device according claim 1 wherein said wireless antenna relatively encloses said screen and is located at borders between said screen and said case body.

9. The antenna configuration structure of said NFC-enabled medical device according claim 1 wherein said wireless antenna is developed as a coiled body with square-ring wiring or circular-ring wiring.

10. The antenna configuration structure of said NFC-enabled medical device according claim 1 wherein said NFC-enabled module is an NFC reader/writer or an NFC tag.

11. The antenna configuration structure of said NFC-enabled medical device according claim 10 wherein said NFC-enabled module comprises a control circuit in which there are a microprocessor and a memory.

12. The antenna configuration structure of the NFC-enabled medical device according claim 11 wherein said microprocessor and said memory are installed on a circuit board.

13. The antenna configuration structure of said NFC-enabled medical device according claim 12 wherein both said control circuit of said NFC-enabled module and said circuit board can be collectively integrated with electronic medical components in terms of said medical device.

14. The antenna configuration structure of said NFC-enabled medical device according claim 1 wherein said wireless antenna is an enameled wire developed as ring-type wiring.

15. The antenna configuration structure of said NFC-enabled medical device according claim 1 wherein said wireless antenna is a circuit board with ring-type wiring.
